(19) United States
(12) Patent Application Publication
(10) Pub. No.: US 2011/0291892 A1
(43) Pub. Date: Dec. 1, 2011

(54) METHOD OF DETERMINING THE DIRECTION OF ARRIVAL OF AN ELECTROMAGNETIC WAVE

(75) Inventors: Arnaud Lecca, Pays (FR); Eric Merlet, Colombes (FR); Jean-Christophe Mesnage, Colombes (FR); Jean-Luc Rogier, Colombes (FR)

(73) Assignee: THALES, Neuilly-Sur-Seine (FR)

(21) Appl. No.: 13/128,367

(22) PCT Filed: Nov. 4, 2009
(86) PCT No.: PCT/EP2009/064594

§ 371 Date: Jul. 11, 2011

(30) Foreign Application Priority Data
Nov. 7, 2008 (FR) 0806233

(51) Int. Cl. G01S 3/02

(52) U.S. Cl. 342/420; 342/442

(57) ABSTRACT

A method of measuring the bearing angle of arrival θ of HF band electromagnetic signals received by a crossed loop antenna or an Adcock antenna array includes measuring the phase difference Δφ between the signals acquired in the sine and cosine paths of the antenna; measuring the ratio R of the amplitudes of the signals acquired in the sine and cosine paths of the antenna; and determining the bearing angle of arrival θ of the wave as a function of the phase difference Δφ and the ratio R. The method is applicable to the detection and location of electromagnetic signal transmitters, particularly in the maritime field.

The present invention relates to a method of determining the direction of arrival of an electromagnetic wave. It is notably applicable to the detection and location of electromagnetic signal transmitters, particularly in the maritime field.

In order to determine the direction of arrival of an electromagnetic signal, it is desirable for the antenna used to capture the signal to be large with respect to the wavelength of the signal. For example, in the case of an HF signal, the size of the antenna should theoretically be as much as several hundred meters. Thus, if the direction of arrival of the signal is measured from a platform of limited size such as a ship or a naval base, the antenna which is used generally has a special geometry enabling its dimensions to be reduced. In most cases, the antenna comprises a monopole and two crossed loops, this type of antenna being commonly known as a “Watson-Watt antenna”, owing to the eponymous algorithm which is conventionally used to determine the bearing angle of an incident signal. In some cases, the crossed loop antenna is replaced by an Adcock antenna array.

However, when operating from either a land- or sea-based platform, if it is desired to determine the direction of arrival of an electromagnetic signal emitted by a remote transmitter placed at ground level, in other words if it is desired to determine the bearing angle of arrival of a signal having a zero or quasi-zero elevation angle, the measurements are sometimes biased by the detection of waves having non-zero elevation angles and non-vertical polarization. This is because, in some cases, some waves captured by the antenna are initially emitted from the ground but are then reflected by the ionosphere which modifies their polarization. Incorrect values will then be obtained for the bearings if the Watson-Watt algorithm is used.

One object of the invention is to improve the measurement of the direction of arrival of electromagnetic signals received on a crossed loop antenna or an Adcock antenna array by applying a method which compensates for the aforesaid drawbacks, notably by allowing for the ellipticity of the carrier wave of the received signals. For this purpose, the invention proposes a method of measuring the angle of arrival θ of HF band electromagnetic signals received by a crossed loop antenna or an Adcock antenna array, characterized in that it comprises at least the following steps:
measuring the phase difference Δφ between the signals acquired in the sine and cosine paths of the antenna;
measuring the ratio R of the amplitudes of the signals acquired in the sine and cosine paths of the antenna;
determining the angle of arrival θ of the wave as a function of the phase difference Δφ and the ratio R.

In one embodiment of the angle measuring method according to the invention, the bearing angle θ is determined by the following relation:

$$tan ( 2. θ ) = \frac{2}{R - \frac{1}{R}} \cdot cos ( Δ ϕ )$$

where

$$R = \frac{‖ {\overline{a}}_{c} ‖}{‖ {\overline{a}}_{s} ‖} ,$$

∥ā_{c}∥ being the amplitude of the signal received in the cosine path, and

∥ā_{c}∥ being the amplitude of the signal received in the sine path.

In one embodiment of the angle measurement method according to the invention, a correction function f_{c} is applied to the measured value of the angle of arrival θ, the values of the correction function being produced during a calibration phase in which the difference between the real angle of arrival of the signals received by the antenna and the measured angle of arrival is recorded.

In one embodiment of the method of measuring the angle according to the invention, a step of evaluating the quality of the measurement of the direction θ is carried out, this step comprising the determination of the angle of ellipticity τ of polarization of the signal responding to the carrier wave of the received signal, a quality score decreasing with the increase of the angle of ellipticity τ being assigned to the measurement of the angle of arrival θ.

In one embodiment of the angle measuring method according to the invention, the angle of ellipticity τ is determined by the following relation:

$$sin ( 2 \cdot τ ) = \frac{2}{R + \frac{1}{R}} \cdot sin ( Δ ϕ )$$

In one embodiment of the angle measurement method according to the invention, an angle measurement by vector correlation is also carried out, the measurement θ₂ produced by the vector correlation being combined with the measurement θ₁ produced by the step of determining the angle of arrival of the wave as a function of the phase difference Δφ and the ratio R, the vector correlation comprising a calibration phase for acquiring and recording the measurements by the antenna of a calibration signal having a variable bearing and a fixed or variable frequency, and a phase of measuring detected signals, this measurement phase comprising at least the following steps:
acquiring the detected signals in at least one frequency channel;
for each frequency channel fᵢ, correlating the acquired signals with the recorded signals resulting from the frequency calibration close to fᵢ, and determining the direction of arrival of the signals by finding the bearing angle θ for which the maximum correlation is obtained.

In one embodiment of the angle measurement method according to the invention, each acquisition in the calibration phase is recorded in a table in the form of an intercorrelation vector, the vectors in this table being subsequently correlated with another intercorrelation vector obtained from the signals acquired in the measurement phase, each of the intercorrelation vectors being calculated by executing at least the following steps:
acquiring, at least on the sine loop and the cosine loop of the antenna, N signal measurements, where N≧1, over a time interval Δt;
for p measurements out of the N measurements made previously, calculating an elementary intercorrelation vector Xₖ;
calculating a mean intercorrelation vector X by finding the mean of the p elementary intercorrelation vectors Xₖ calculated previously.

In one embodiment of the angle measurement method according to the invention, an elementary intercorrelation vector Xₖ obtained from a measurement k is defined thus:

$${X}_{k} = \frac{1}{{‖ {X}_{0 , k} ‖}^{2}} \cdot ( \begin{matrix}{X}_{0 , k} \cdot {X}_{0 , k}^{H} \\ {X}_{0 , k} \cdot {X}_{c , k}^{H} \\ {X}_{0 , k} \cdot {X}_{s , k}^{H}\end{matrix} ) ,$$

where X_{0,k} is the complex measurement acquired on the monopole, X_{c,k} is the complex measurement acquired on the cosine loop, X_{s,k} is the complex measurement acquired on the sine loop, and ^{H} is the Hermitian operator.

The invention also proposes a goniometer using an angle measurement method as described above.

The angle measurement method as described above can be used on a ship or a maritime platform, the antenna being fixed to the ship or platform, and the method being used to locate the bearings of transmitters placed on vessels moving within a radius of several hundred kilometers of the ship or platform.

Other characteristics will be made clear by the following detailed description, given by way of non-limiting example with reference to the appended drawings, in which:

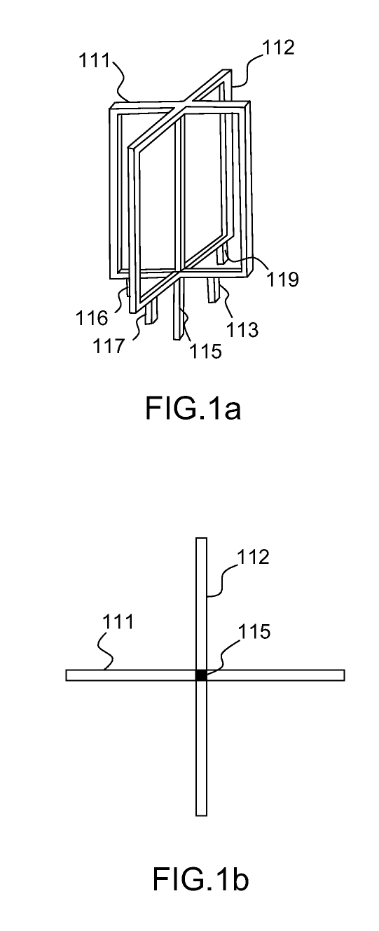

FIGS. 1a and 1b show a perspective view and a top view of a first example of a crossed loop antenna receiving the signals processed by the method according to the invention,

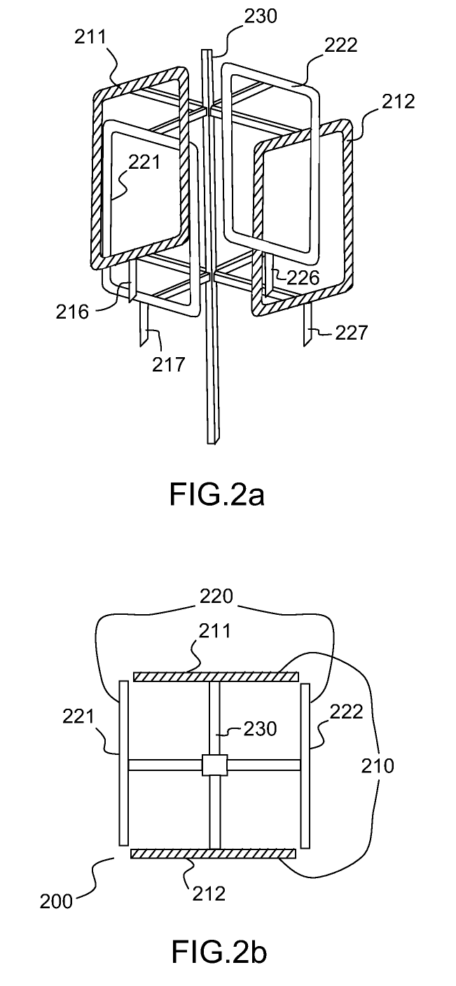

FIGS. 2a and 2b show a perspective view and a top view of a second example of a crossed loop antenna receiving the signals processed by the method according to the invention,

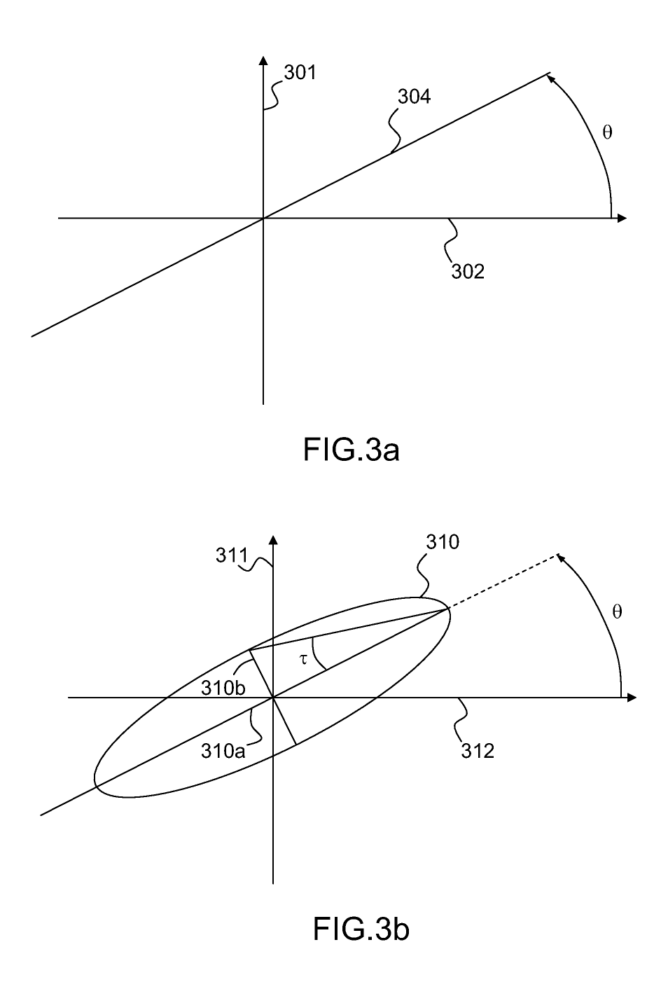

FIG. 3a is a diagram illustrating a phase difference between the signals received on the antenna loops when the carrier wave of the signals is vertically polarized,

FIG. 3b is a diagram illustrating a phase difference between the signals received on the antenna loops when the carrier wave of the signals is not vertically polarized,

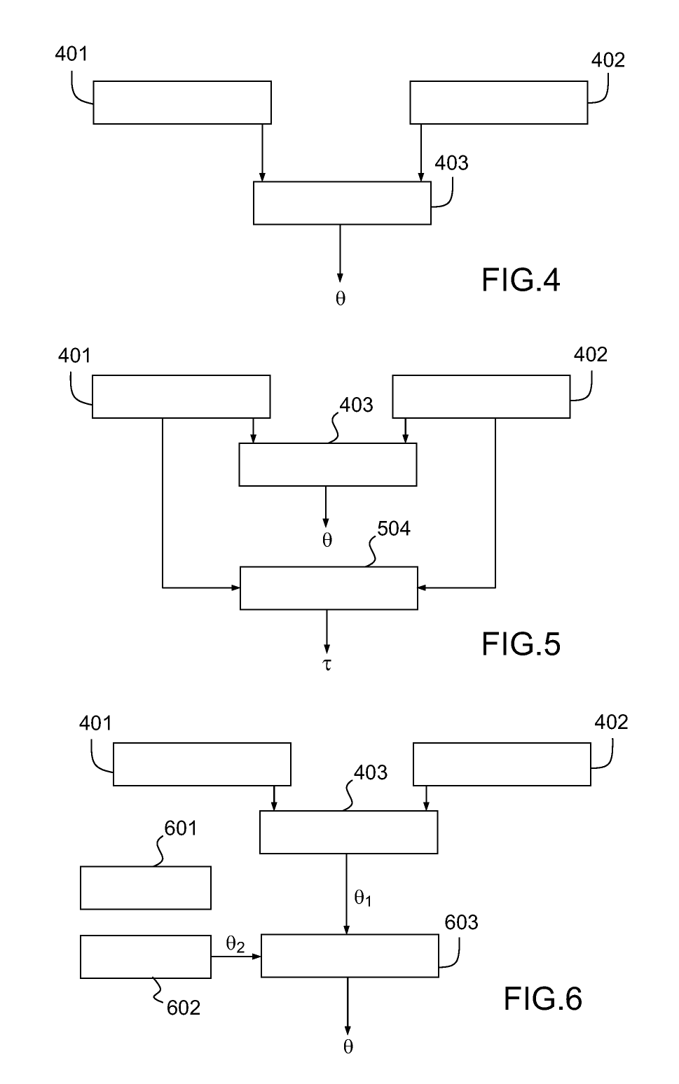

FIG. 4 is a synoptic diagram showing the steps of a first use of the method according to the invention,

FIG. 5 is a synoptic diagram showing the steps of a second use of the method according to the invention,

FIG. 6 is a synoptic diagram showing the steps of a third use of the method according to the invention.

For the sake of clarity, the same references in different figures indicate the same objects.

FIGS. 1a and 1b show a first example of a crossed loop antenna receiving the signals processed by the angle measurement method according to the invention. FIG. 1a is a perspective view of the antenna, while FIG. 1b shows the antenna viewed from above.

The antenna 100 comprises a first loop 111 orthogonal to a second loop 112, the two loops 111 and 112 in this example being formed by metal rectangles held by a support 115 and lying in substantially vertical planes. The first loop 111 is sometimes known as the “sine loop”, the second loop 112 being known as the “cosine loop”. The antenna 100 in this example comprises a third reception channel in the form of a monopole formed by vertical metal rods 116, 117, 118, 119 placed under the loops 111, 112.

FIGS. 2a and 2b show a second example of a crossed loop antenna receiving the signals processed by the angle measurement method according to the invention. FIG. 2a is a perspective view of the antenna, while FIG. 2b shows the antenna viewed from above.

The antenna 200 comprises two pairs 210, 220 of loops held by a support 230, the loops of each pair 210, 220 being parallel to each other, the loops 211, 212 of the first pair 210 being orthogonal to the loops 221, 222 of the second pair 220, and all the loops 211, 212, 221, 222 of the antenna being, in this example, metal rectangles lying in substantially vertical planes. In the example, the pairs of loops 210, 220 are held around the support 230 in such a way that they substantially form a square when viewed from above. In the example, the antenna also comprises a substantially vertical metal rod 216, 217, 226, 227 under each loop 211, 212, 221, 222, the set of these rods 216, 217, 226, 227 forming the monopole channel of the antenna. From a theoretical viewpoint, this antenna is equivalent to the antenna shown in FIGS. 1a and 1b. The terms “sine loop” and “cosine loop” will be used henceforth to refer to the first type of antenna shown in FIGS. 1a and 1b, these terms being applied to the pairs 210, 220 of loops 211, 212, 221, 222 when the method is used with the second type of antenna shown in FIGS. 2a and 2b.

In another embodiment of the method according to the invention, the crossed loop antenna is replaced by an Adcock antenna array, which can be modeled in a similar way to crossed loop antennas, in other words by at least a sine loop and a cosine loop.

The monopole of the antenna can also be replaced with a dipole or any other antenna serving as a reference channel.

The diagram in FIG. 3a illustrates the phase difference between the signals received on the antenna loops when the carrier wave of the signals is vertically polarized. The voltage received by the sine loop is shown on the vertical axis 301, while the voltage received by the cosine loop is shown on the horizontal axis 302. The phase difference between the received signals is shown by a straight line 304.

If the carrier wave of the signal is non-vertically polarized, or if it has been affected by reflectors in the proximity of the receiving antenna, the signals received on the sine and cosine channels are subject to an additional phase difference resulting in an elliptical response of the loops, as shown in FIG. 3b.

The diagram in FIG. 3b illustrates the phase difference between the signals received on the antenna loops when the carrier wave of the signals is elliptically polarized. The voltage received by the sine loop is shown on the vertical axis 311, while the voltage received by the cosine loop is shown on the horizontal axis 312. The phase difference between the received signals is shown by a straight line 310.

The signal received on the monopole and the sine and cosine loops of an antenna can therefore be expressed thus:

$$\{ \begin{matrix}{U}_{0} ( t ) = Re ( β \cdot s ( t ) \cdot {e}^{j ϖ t} ) = Re ( {\overline{a}}_{0} ( t ) \cdot {e}^{jϖ t} ) \\ {U}_{c} ( t ) = Re ( α \cdot s ( t ) \cdot cos ( θ ) \cdot {e}^{jϖ t} ) = Re ( {\overline{a}}_{c} ( t ) \cdot {e}^{jϖ t + {ϕ}_{0} + Δ ϕ} ) \\ {U}_{s} ( t ) = Re ( α \cdot s ( t ) \cdot sin ( θ ) \cdot {e}^{j ϖ t} ) = Re ( {\overline{a}}_{s} ( t ) \cdot {e}^{j ( ϖ t + {ϕ}_{0}} )\end{matrix}$$

where U₀, U_{c} and Uₛ denote the antenna output voltages on the monopole, the cosine loop and the sine loop respectively, s(t) denotes the modulating signal, ω denotes the pulsation of the carrier wave, the complex terms α and β are dependent on the effective height of a loop and of the monopole respectively, the terms ā₀, ā_{c} and āₛ denote the complex envelopes of the signals, φ₀ denotes the phase difference between the sine loop and the monopole, and Δφ denotes the phase difference between the signal received on the sine loop and the cosine loop, the phase difference Δφ being zero when the wave is vertically polarized. The coefficients α and β are determined during the calibration of the antenna in its working environment, by using a vertically polarized wave with zero incidence and comparing the antenna response with the theoretical antenna responses (in cos(θ) and sin(θ) with α and β equal to 1).

FIG. 4 is a synoptic diagram showing the steps of a first use of the method according to the invention.

In a first time interval 401, the phase difference Δφ between the signals received on the sine loop and on the cosine loop is measured. Simultaneously 402, the ratio between amplitude ∥ā_{c}∥ of the signal received on the cosine loop and the amplitude ∥āₛ∥ of the signal received on the sine loop is determined.

Subsequently 403, the bearing angle of arrival of the carrier wave of the signals is determined from the phase difference Δφ and the ratio R between ∥ā_{c}∥ and ∥āₛ∥. The bearing angle of arrival θ can be expressed as a function of these two values, as follows:

$$tan ( 2 \cdot θ ) = \frac{2 \cdot ‖ {\overline{a}}_{c} ‖ \cdot ‖ {\overline{a}}_{s} ‖}{{‖ {\overline{a}}_{c} ‖}^{2} - {‖ {\overline{a}}_{s} ‖}^{2}} \cdot cos ( Δ ϕ ) = \frac{2}{\frac{‖ {\overline{a}}_{c} ‖}{‖ {\overline{a}}_{s} ‖} - \frac{‖ {\overline{a}}_{s} ‖}{‖ {\overline{a}}_{c} ‖}} \cdot cos ( Δ ϕ ) \qquad ( E 1 )$$

Moreover, since ∀kεZ, tan (2·θ)=tan(2·θ+kπ), equation (E1) can only be used to determine θ to an accuracy of k·π/2.

In order to remove the ambiguity at (2·k+1)·π/2, that is to say in order to determine the dimension of the major axis 210a of the ellipse 210, the rotation of angle θ of the responses is calculated on the cosine axis and on the sine axis as follows:

$$If ‖ cos ( θ ) \cdot {\overline{a}}_{c} + sin ( θ ) \cdot {\overline{a}}_{s} ‖ < ‖ cos ( θ ) \cdot {\overline{a}}_{s} - sin ( θ ) \cdot {\overline{a}}_{c} ‖ , \\ then \\ θ = θ + \frac{π}{2} \qquad ( E 2 )$$

In order to remove the ambiguity at k·π, that is to say in order to determine the dimension of the minor axis 210b of the ellipse 210, the following value φ₁ is calculated:

φ₁=arg(ā_{c}+j·āₛ)−arg(ā₀)−arg(α)+arg(β)−θ (E3)

where arg(z) represents the argument of the complex number z. In a perfect antenna, φ₁ equals 0 or π. In order to allow for model errors, the following rule should be applied:

$$If ‖ {ϕ}_{1} ‖ > \frac{π}{2} , \\ then \\ θ = θ + π \qquad ( E4 )$$

Additionally, in order to compensate for the model errors, the value of the bearing angle θ obtained is preferably corrected by a function f_{c} generated by a phase of calibration of the measuring instruments used to determine the bearing angle θ:

θ_{c}=θ+f_{c}(θ) (E5)

During the phase of instrument calibration, signals having a known bearing angle of arrival are transmitted toward the antenna. This makes it possible to measure the difference between the real bearing angle and the measured bearing angle for a plurality of transmission angles, these measured differences being values of the function f_{c}. Discrete values of the function f_{c} are generally stored in a correction table. The values stored in this table are subsequently used to correct the measured angles.

At the end of the procedure shown in FIG. 4, an angle θ is obtained, this angle θ being the estimate of the bearing angle of arrival of the signals received by the crossed loop antenna.

FIG. 5 is a synoptic diagram showing the steps of a second use of the method according to the invention. This case differs from the first use shown in FIG. 4 in that a reliability score is assigned to the estimated value of the direction of arrival of the received signal. This reliability score depends on the ellipticity angle τ of the antenna's response signal to the carrier wave of the received signal. This is because the electromotive force induced by the magnetic field flux of the incident wave through each loop of the antenna has an elliptical shape if the polarization of the incident wave is elliptical. In the example, the score assigned is a decreasing function of the value τ of the ellipticity angle. The value τ is calculated by means of the following relation:

$$sin ( 2 \cdot τ ) = \frac{2 \cdot ‖ {\overline{a}}_{c} ‖ \cdot ‖ {\overline{a}}_{s} ‖}{{‖ {\overline{a}}_{c} ‖}^{2} + {‖ {\overline{a}}_{s} ‖}^{2}} \cdot sin ( Δ ϕ ) = \frac{2}{\frac{‖ {\overline{a}}_{c} ‖}{‖ {\overline{a}}_{s} ‖} + \frac{‖ {\overline{a}}_{s} ‖}{‖ {\overline{a}}_{c} ‖}} \cdot sin ( Δ ϕ ) \qquad ( E6 )$$

FIG. 6 is a synoptic diagram showing the steps of a third use of the method according to the invention. This differs from the procedure of FIG. 4 in that a vector correlation comprising two phases 601 and 602 is added. A first phase 601 of calibration and a second phase 602 of bearing angle measurement by vector correlation are therefore added. The first calibration phase 601 should not be confused with the calibration of the measuring instruments described above. The first calibration phase 601 is essential for the execution of the second phase 602 of measurement of the bearing angle by vector correlation. This step 602 of vector correlation can be used to correct the angle determined by the method of FIG. 4. For example, a bearing angle can be determined 603 by calculating the mean of the value found with the procedure of FIG. 4 and the value found by the vector correlation 602.

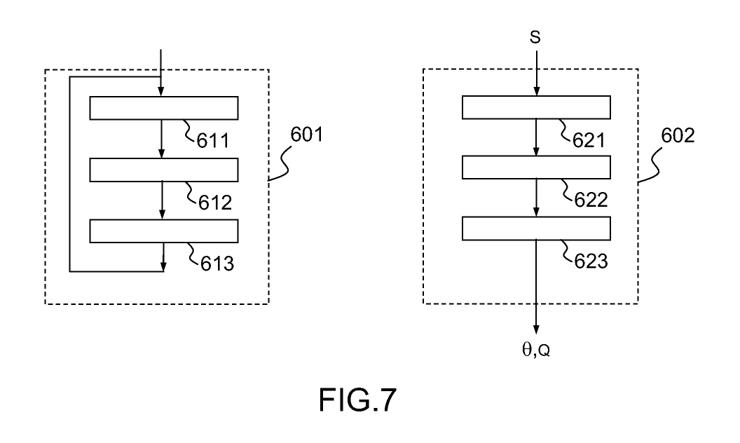

The synoptic diagram of FIG. 7 shows the details of the first calibration phase 601 and the second phase 602 of measurement of the bearing angle by vector correlation. The first phase 601 is a preparatory phase of antenna calibration, and the second phase 602 is a measurement phase having the purpose of measuring the direction of arrival of a signal received by the antenna. In the example, the crossed loop antenna comprises two orthogonal loops and a monopole.

The first calibration phase 601 is executed in the conditions of the end use of the antenna. For example, if physical structures are present in the proximity of the antenna in normal conditions, the calibration is carried out in the presence of these structures, which can modify the antenna response by creating distinctive electromagnetic couplings. Electromagnetic calibration signals are transmitted toward the antenna while their transmission frequency and their angle of arrival are varied. A calibration table can then be constructed by recording the responses of the antenna to signals varying in their frequencies and bearings.

For example, a fixed transmitter is placed at a distance from a ship having a crossed loop antenna. The transmitter is operated so as to transmit signals by sweeping a frequency band to be calibrated, and the ship is then moved in order to vary the bearing angle of arrival of the signals at the antenna. The antenna must not be moved with respect to the ship during the calibration phase 601, as this would falsify the electromagnetic conditions of reception. Additionally, the elevation angle of arrival of the signals at the receiving antenna is chosen to correspond to the cases of application of the angle measurement method according to the invention. For example, if the method is used by ships to determine the direction of arrival of signals transmitted by other ships, the elevation angle chosen for the calibration will be zero or practically zero.

Additionally, in special cases of use, the frequency of the calibration signal is kept fixed, notably if it is only desired to detect specific signals whose frequency is known in advance.

More precisely, the calibration phase 601 of FIG. 7 comprises a first step 611 of signal acquisition and detection, a second step 612 of calculation of an acquisition vector corresponding to the transmitted signals, and a third step 613 of storage of the acquisition vector in the calibration table. In the example, these three steps 611, 612 and 613 are executed for a fixed bearing angle and for transmission frequencies varying in the high frequency range, after which these steps 611, 612 and 613 are reiterated with different bearing angles, until all the desired bearing angles have been covered.

In the first step 611, acquisition frequencies are chosen from the signal transmission frequencies. For each chosen acquisition frequency F, the signal with the frequency F received by the crossed loop antenna is then acquired in three channels: namely a monopole channel X₀, a channel corresponding to the first loop X_{c} of the antenna, sometimes known as the “cosine loop”, and a channel corresponding to the second loop Xₛ of the antenna, sometimes called the “sine loop”. Preferably, a plurality of signal measurements are acquired in succession in these three channels X₀, X_{c}, Xₛ, this first step 611 of signal acquisition then being executed, preferably, over a time interval Δt_{cal} which is long enough for the acquisition of a series of measurements, but short enough for the bearing angle of arrival of the signals to remain practically unchanged during the series of measurements if the antenna is moving with respect to the signal transmitter. Thus, at the end of the first step 611, N acquisitions X_{0,1}, . . . , X_{0,N} on the monopole channel, N acquisitions X_{c,1}, . . . , X_{c,N} on the cosine channel and N acquisitions X_{s,1}, . . . , X_{s,N} on the sine channel have been completed for each acquisition frequency F.

In the second step 612, an intercorrelation vector X between the three channels, referred to as a reference channel, is calculated for each acquisition frequency F. For an observation k, 1≦k≦N, the elementary intercorrelation vector Xₖ corresponding to the acquisitions of the observation k is determined as follows:

$${X}_{k} = \frac{1}{{‖ {X}_{0 , k} ‖}^{2}} \cdot ( \begin{matrix}{X}_{0 , k} \cdot {X}_{0 , k}^{H} \\ {X}_{0 , k} \cdot {X}_{c , k}^{H} \\ {X}_{0 , k} \cdot {X}_{s , k}^{H}\end{matrix} )$$

where X_{0,k} is the complex measurement acquired on the monopole, X_{c,k} is the complex measurement acquired on the cosine loop, X_{s,k} is the complex measurement acquired on the sine loop, and ^{H} is the Hermitian operator. The reference channel chosen in the example is the channel corresponding to the monopole. In other applications of the angle measurement method according to the invention, the chosen reference channel is that of the sine loop or the cosine loop.

In the example, the intercorrelation vector X is calculated by finding the mean of the measurements acquired in a number s of observations, where s≦N, so as to limit the effect of noise on the intercorrelation vector X:

$$X = \frac{1}{s} {\sum }_{k = 1}^{s} {X}_{k}$$

Additionally, the intercorrelation vector X is preferably normalized to 1:

$${X}_{norm} = \frac{X}{‖ X ‖}$$

In the third step 613, the data characterizing the acquired signals are stored in the calibration table for each acquisition frequency F. In the example, these characterizing data are stored in the form of normalized intercorrelation vectors Xₙₒᵣₘ, calculated previously for each acquisition frequency F. The calibration table is thus populated with the normalized intercorrelation vectors formed from detections and acquisitions of signals having different frequencies.

The first step 611, the second step 612 and the third step 613 are reiterated successively for different angles of arrival, in such a way that, at the end of the calibration phase 601, p normalized intercorrelation vectors Xₙₒᵣₘ(θ₁), . . . , Xₙₒᵣₘ(θₚ) are stored for each acquisition frequency, each of the vectors corresponding to a signal received with a different bearing angle of arrival θ₁, . . . , θₚ. For this reason, an intercorrelation vector stored in the calibration is subsequently described as a “directional vector”.

In another embodiment of the calibration phase 601, the first step 611, the second step 612 and the third step 613 are carried out for a fixed frequency and for varying bearing angles. The steps 611, 612, 613 are then reiterated while the transmission frequency is modified. For example, a mobile transmitter is moved around the antenna and the transmitter modifies its transmission frequency after the completion of a full revolution, in such a way that, after q revolutions, q different frequencies are calibrated.

When the calibration phase 601 has been completed, one or more measurement phases 602 can be carried out. A measurement phase 602 enables the direction of arrival of a detected signal to be determined. The measurement phase 602 of FIG. 7 comprises a first signal detection and acquisition step 621, a second acquisition vector calculation step 622, and a third step 623 of correlation between the acquisition vector and vectors resulting from the calibration.

In the first step 621, the received signal is acquired over a time interval Δt and is divided into a plurality of frequency channels. At the end of the first step 621, one or more acquisitions of the signal is/are carried out for each frequency channel, preferably over the three channels of the antenna.

In the second step 622, an intercorrelation vector is calculated from the acquisitions carried out in the first step 621. The intercorrelation vector is calculated according to the same method as that described previously for the second step 612 of the calibration phase. At the end of this second step 622, an acquisition vector Xₙₒᵣₘ, formed on the basis of the signals acquired by the antenna, is obtained for each frequency channel to be analyzed.

In the third step 623, vector correlation calculations are carried out to determine the direction of arrival of the signals received by the antenna. In the example, the correlation criterion used is the squared modulus of the complex scalar product of acquisition vectors. Thus, for each frequency channel analyzed, the directional vectors which correspond to different bearing angles and to a frequency close to this frequency channel and which are recorded in the calibration table are identified, following which the squared modulus of the complex scalar products of the acquisition vector Xₙₒᵣₘ formed from the signal acquired by the antenna on this frequency channel and each of the identified directional vectors is calculated. For each frequency channel, the maximum of this modulus is found, the directional vector of the calibration table enabling this maximum to be determined as the maximum corresponding to the angle of arrival of the received signal, as shown by the following expression:

$$θ ( f ) = {arg max}_{k} ( {\vert {X}_{norm} \cdot T ( f , {θ}_{k} ) \vert}^{2} )$$

where f, in this example, is the central frequency of the frequency channel used, Xₙₒᵣₘ is the acquisition vector of the signal whose direction of arrival is to be determined, and T(f,θₖ) is a directional vector recorded in the calibration table and corresponding to a frequency signal f reaching the antenna with a bearing angle θ.

At the end of the measurement phase 602, a bearing angle measurement θ is found for each frequency channel analyzed. Additionally, a quality score Q is associated with each bearing angle measurement θ that is found, this score being related to the level reached by the correlation criterion. A maximum score is obtained when the vectors Xₙₒᵣₘ and T(f,θ) are collinear, while a lower score is obtained when the angle formed between the vectors Xₙₒᵣₘ and T(f,θ) increases. In the example, Q is given by the following relation:

$$Q ( f ) = {max}_{k} ( {\vert {X}_{norm} \cdot T ( f , {θ}_{k} ) \vert}^{2} )$$

where “·” represents the complex scalar product.

A number of different bearing angles can be determined, for example if a plurality of transmitters in different directions transmit signals simultaneously.

Additionally, a more precise bearing angle of arrival θ can be obtained by calculating an interpolated value based on a number of bearing angle values θᵢ around the maximum correlation. For example, a quadratic interpolation can be carried out on the basis of the three values around the determined maximum.

1. A method of measuring the bearing angle of arrival θ of HF band electromagnetic signals received by a crossed loop antenna or an Adcock antenna array, said method comprising:
measuring the phase difference Δφ between the signals acquired in the sine and cosine paths of the antenna;
measuring the ratio R of the amplitudes of the signals acquired in the sine and cosine paths of the antenna;
determining the bearing angle of arrival θ of the wave as a function of the phase difference Δφ and the ratio R.

2. The method according to claim 1, wherein the bearing angle θ is determined by the following relation:
$$tan ( 2 \cdot θ ) = \frac{2}{R - \frac{1}{R}} \cdot cos ( Δϕ )$$
where
$$R = \frac{‖ {\overline{a}}_{c} ‖}{‖ {\overline{a}}_{s} ‖} ,$$
∥ā_{c}∥ being the amplitude of the signal received in the cosine path, and
∥ā_{c}∥ being the amplitude of the signal received in the sine path.

3. The method according to claim 1, wherein a correction function f_{c} is applied to the measured value of the bearing angle of arrival θ, the values of the correction function being produced during a calibration phase in which the difference between the real angle of arrival of the signals received by the antenna and the measured angle of arrival is recorded.

4. The method according to claim 1, further comprising:
evaluating the quality of the measurement of the direction θ, the evaluating comprising a determination of the angle of ellipticity τ of polarization of the signal responding to the carrier wave of the received signal, a quality score decreasing with the increase of the angle of ellipticity τ being assigned to the measurement of the angle of arrival θ.

5. The method according to claim 4, wherein the angle of ellipticity τ is determined by the following relation:
$$sin ( 2 \cdot τ ) = \frac{2}{R + \frac{1}{R}} \cdot sin ( Δ ϕ )$$

6. The method according to claim 1, further comprising:
executing an angle measurement by vector correlation, the measurement θ₂ produced by the vector correlation being combined with the measurement θ₁ produced by the step of determining the bearing angle of arrival of the wave as a function of the phase difference Δφ and the ratio R, the vector correlation comprising a calibration phase for acquiring and recording the measurements by the antenna of a calibration signal having a variable bearing and a fixed or variable frequency, and a measurement phase of measuring detected signals, the measurement phase comprising:
acquiring the detected signals in at least one frequency channel; and
for each frequency channel t, correlating the acquired signals with the recorded signals resulting from the frequency calibration close to and determining the direction of arrival of the signals by finding the bearing angle θ for which the maximum correlation is obtained.

7. The method according to claim 6, wherein each acquisition in the calibration phase is recorded in a table in the form of an intercorrelation vector, the vectors in this table being subsequently correlated with another intercorrelation vector obtained from the signals acquired in the measurement phase, calculating each of the intercorrelation vectors comprising:
acquiring, at least on the sine loop and the cosine loop of the antenna, N signal measurements, where N≧1, over a time interval Δt;
for p measurements out of the N measurements made previously, calculating an elementary intercorrelation vector Xₖ; and
calculating a mean intercorrelation vector X by finding the mean of the p elementary intercorrelation vectors Xₖ calculated previously.

8. The method according to claim 7, wherein an elementary intercorrelation vector Xₖ based on a measurement k is defined thus:
$${X}_{k} = \frac{1}{{‖ {X}_{0 , k} ‖}^{2}} \cdot ( \begin{matrix}{X}_{0 , k} \cdot {X}_{0 , k}^{H} \\ {X}_{0 , k} \cdot {X}_{c , k}^{H} \\ {X}_{0 , k} \cdot {X}_{s , k}^{H}\end{matrix} ) ,$$
where X_{0,k} is the complex measurement acquired on the monopole, X_{c,k} is the complex measurement acquired on the cosine loop, X_{s,k} is the complex measurement acquired on the sine loop, and ^{H} is the Hermitian operator.

9. A goniometer using an angle measurement method according to claim 1.

10. The use of the angle measurement method according to claim 1 on a ship or a maritime platform, the antenna being fixed to the ship or platform, and the method being used to locate the bearings of transmitters placed on vessels moving within a radius of several hundred kilometers of the ship or platform.
